(19) United States
(12) Patent Application Publication
(10) Pub. No.: US 2012/0113660 A1
(43) Pub. Date: May 10, 2012

(54) DOOR MIRROR LAMP

(75) Inventors: Tomomi Ishikawa, Shizuoka (JP); Atsushi Ishigami, Shizuoka (JP)

(73) Assignee: KOITO MANUFACTURING CO., LTD., Tokyo (JP)

(21) Appl. No.: 13/291,478

(22) Filed: Nov. 8, 2011

(30) Foreign Application Priority Data
Nov. 8, 2010 (JP) 2010-249945

(51) Int. Cl. B60Q 1/34

(52) U.S. Cl. 362/494

(57) ABSTRACT

A door mirror lamp that is attached to an opening portion formed in an outer side surface of a mirror housing, has a light guide member having an incident-side end surface, an output-side end surface, and first and second side surfaces that are formed as substantially opposite surfaces of the light guide member, wherein the light guide member is attached to the mirror housing such that the output-side end surface and of the first side surface are exposed at the opening portion, and a semiconductor light emitting element that is disposed in a vicinity of the incident-side end surface and that emits light that enters an inside of the light guide member from the incident-side end surface. The second side surface is provided with visual identification prevention portion that prevents a configuration inside the mirror housing from being visually identified through the second side surface from outside.

### BACKGROUND

1. Technical Field

The present invention relates to a vehicular door mirror lamp, as represented by a side turn signal lamp.

2. Related Art

A side turn signal lamp is known that is built into a vehicular side mirror, and that emits a light from its light emitting surface provided along an outer side surface of the side mirror when, for example, a vehicle turns in a certain direction (for example, refer to Patent Document 1).

A side turn signal lamp of related art includes: a lamp body made of a material that does not transmit light; a light guide member made of a translucent or transparent material, which guides the light incident on a predetermined entrance surface and outputs the light from a light emitting surface; and a light source unit that includes a light source that emits light that enters the light guide member, a power source circuit that supplies electricity to the light source, and the like. The side turn signal lamp is attached to an opening portion formed in an outer side wall of a mirror housing.
Patent Document 1: Japanese Patent Application Laid-Open (Kokai) No. 2006-114309

### SUMMARY

Inside the mirror housing, a large storage space for a door mirror main body, a drive unit that drives the door mirror main body, and the like is required. Therefore, according to one or more embodiments of the present invention, the side turn signal lamp that is provided inside the mirror housing, together with the associated components, are smaller and thinner.

One or more embodiments of the present invention provides a door mirror lamp that is attached to an opening portion formed in an outer side surface of a mirror housing that is characterized by including: a light guide member that has an incident-side end surface, an output-side end surface, and a pair of side surfaces that are formed as substantially opposite surfaces of the light guide member, and that is attached to the mirror housing in a manner such that the output-side end surface and one of the pair of side surfaces are exposed at the opening portion; a semiconductor light emitting element that is disposed in a vicinity of the incident-side end surface and that emits light that enters the inside of the light guide member from the incident-side end surface. In the door mirror lamp, the other of the pair of side surfaces is provided with visual identification prevention means for preventing a configuration inside the mirror housing from being visually identified through the other side surface from the outside.

According to the door mirror lamp thus configured, because the lamp body is not provided on an inner side of the light guide member (inside the mirror housing), the lamp itself can be smaller and thinner, and moreover, the number of components can be reduced. In addition, the visual identification prevention means is provided on the side surface of the light guide member, and therefore the configuration inside the mirror housing can be prevented from being visually identified through the light guide member from the outside.

Further, in the door mirror lamp as described above, the visual identification prevention means may include a prism step that is formed on the other side surface.

This can make it difficult to visually identify the configuration inside the mirror housing from the outside only by using the shape of the side surface of the light guide member, and thus an increase of the number of components due to addition of the visual identification prevention means does not occur.

In addition, in the door mirror lamp as described above, the visual identification prevention means may include a light transmission prevention layer that is formed on the other side surface, and that prevents transmission of the light to the inside of the light guide member through the other side surface.

This more reliably makes it difficult to visually identify the configuration inside the mirror housing from the outside, and moreover, forming the visual identification prevention means does not lead to an increase of the number of components by using, for example, deposition as a method of forming the light transmission prevention layer.

Furthermore, when the light transmission prevention layer as described above is formed, according to one or more embodiments of the present invention, the light transmission prevention layer may be a reflection layer that reflects the light from the inside of the light guide member.

This can improve efficiency of using the light from the light source by preventing leakage of the light from the light guide member to the inside of the mirror.

In the door mirror lamp as described above, according to one or more embodiments of the present invention, a hydrophilic layer may be formed at least on the other side surface.

This more reliably makes it further difficult to visually identify the configuration inside the mirror housing by, for example, preventing formation of water drops due to water adhering to the other side surface so as to stabilize the condition of light refraction.

### BRIEF DESCRIPTION OF THE DRAWINGS

FIG. 1 is a front view of a side turn signal lamp 10 according to an embodiment of the present invention.

FIG. 2 is a cross-sectional view of the side turn signal lamp 10 taken along a line II-II shown in FIG. 1.

FIG. 3 is a cross-sectional view of the side turn signal lamp 10 taken along a line III-III shown in FIG. 2.

FIG. 4 is an enlarged view of the vicinity of an LED 320 shown in FIG. 2.

FIG. 5 is an exploded perspective view of the side turn signal lamp 10.

FIG. 6 is a cross-sectional view of a side turn signal lamp 11 according to another embodiment of the present invention, which corresponds to FIG. 2.

FIG. 7 is a cross-sectional view of the side turn signal lamp 11 taken along a line IV-IV shown in FIG. 6.

### DETAILED DESCRIPTION

Hereinafter, embodiments of the present invention will be described, which does not intend to limit the invention according to the claims. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. All of the features and combinations described below are not necessarily essential.

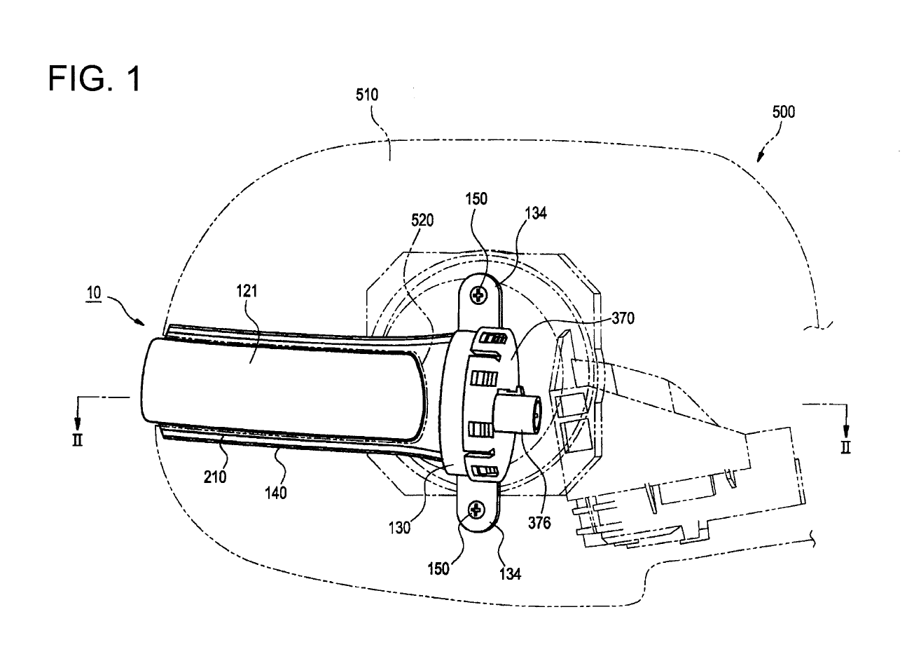

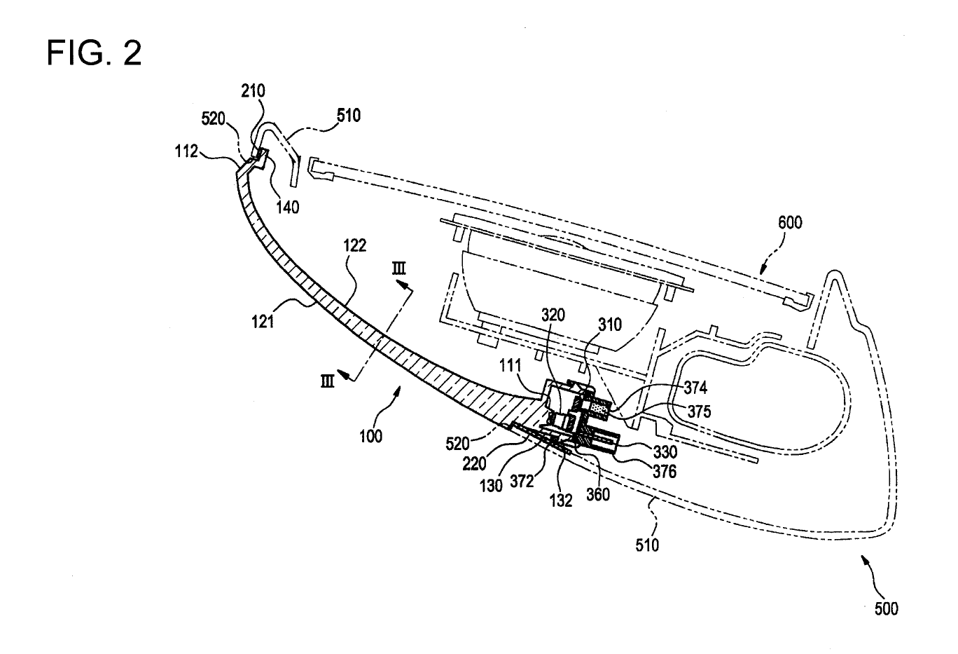

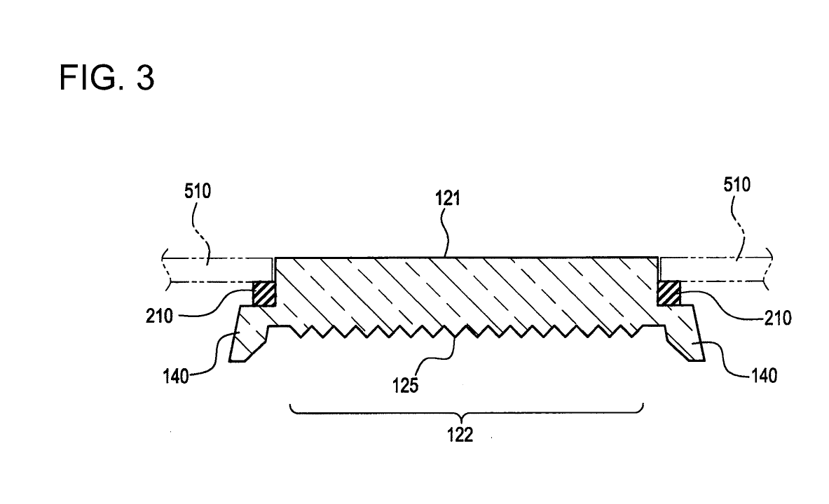

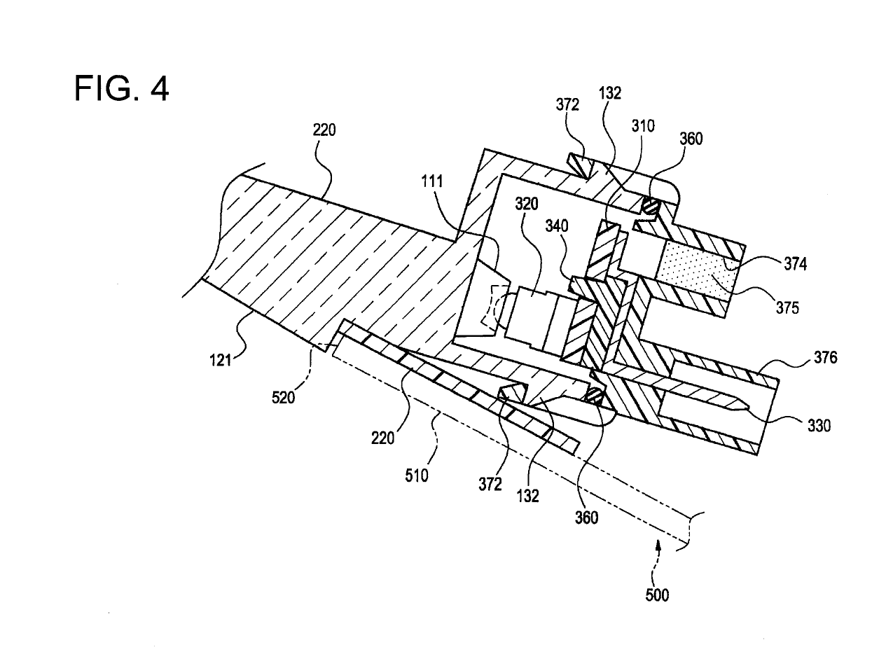

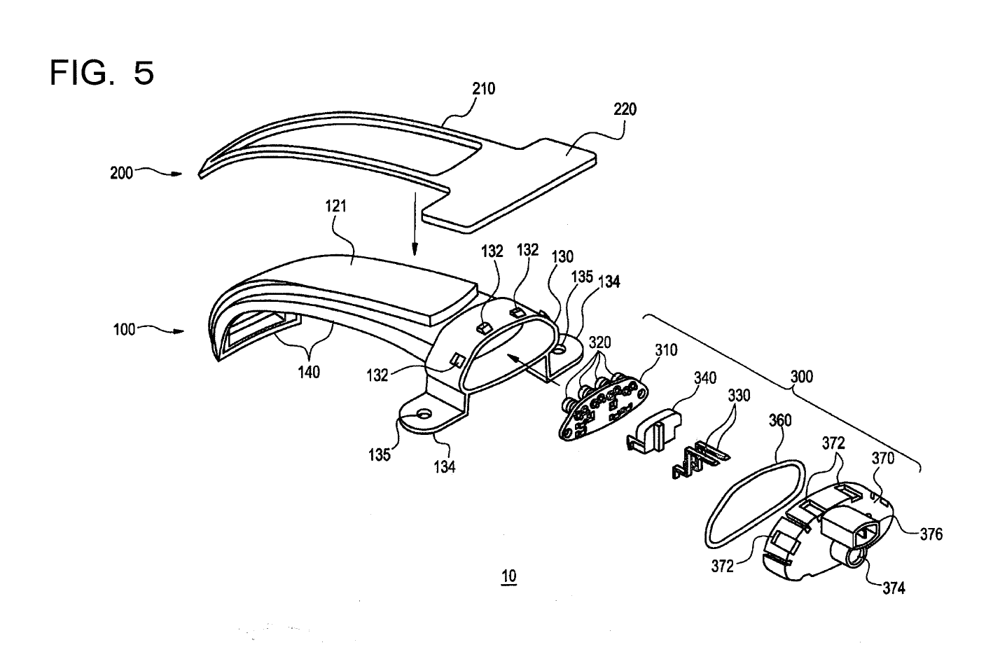

FIG. 1 is a front view of a side turn signal lamp 10 according to an embodiment of the present invention. FIG. 2 is a cross-sectional view of the side turn signal lamp 10 taken along the line II-II shown in FIG. 1. FIG. 3 is a cross-sectional view of the side turn signal lamp 10 taken along the line III-III shown in FIG. 2. FIG. 4 is an enlarged view of the vicinity of an LED 320 shown in FIG. 2. FIG. 5 is an exploded perspective view of the side turn signal lamp 10.

The side turn signal lamp 10 is an example of a door mirror lamp installed in a vehicular door mirror according to one or more embodiments of the present invention. As shown in FIG. 5, the side turn signal lamp 10 mainly includes a light guide member 100, a protector 200, and an LED unit assembly 300. As shown in FIGS. 1 and 2, the side turn signal lamp 10 is attached to an opening portion 520 formed in a curved outer side wall 510 (outer side surface) of a mirror housing 500 that supports a mirror main body 400 of the vehicular side mirror. It should be noted that, in the description below, a “distal end side” indicates a distal end side of the light guide member 100 in the side turn signal lamp 10 (for example, the left side in FIG. 1). Further, a “base end side” indicates an LED unit assembly 300 side (for example, the right side in FIG. 1) in the side turn signal lamp 10.

The light guide 100 is a single-piece resin component that is molded from, for example, a transparent or a translucent resin. The light guide 100 has an incident-side end surface 111, an output-side end surface 112 from which a light that has been emitted from the LED 320 and incident on the light guide member 100 is output, and a pair of side surfaces (a front surface portion 121, a back surface portion 122) formed as substantially opposite surfaces of the light guide member 100. When the side turn signal lamp 10 is attached to the opening portion 520, the output-side end surface 112 and the front surface portion 121 are exposed at the opening portion 520. It should be noted that, in one or more embodiments of the present invention, when the side turn signal lamp 10 is attached to the opening portion 520, the front surface portion 121 of the light guide member 100 is adjacent to the outer side wall 510 of the mirror housing 500, and the front surface portion 121 and the outer side wall 510 form a substantially continuous curved surface.

The incident-side end surface 111 of the light guide member 100 is formed so as to correspond to each of four LEDs 320 (described later) that serve as a light source of the side turn signal lamp 10, and disposed opposing and close to a light emitting portion of the corresponding one of the LEDs 320. The output-side end surface 112 is formed at the distal end side of the light guide member 100. A light from the light source is incident on the incident-side end surface 111 and enters the inside of the light guide member 100. Part of the light that has entered the inside of the light guide member 100 reaches a distal end portion of the light guide member 100 after internally reflected by the front surface portion 121 and the back surface portion 122 of the light guide member 100. The light that has reached the distal end portion is output from the output-side end surface 112.

A light source housing portion 130 that is substantially cylindrical and houses the LEDs 320 is provided in the vicinity of the incident-side end surface 111 of the light guide member 100, and integrally formed with other portions of the light guide member 100. The light source housing portion 130 is open at the base end. A plurality of engagement tabs 132 is provided on an outer side of a peripheral wall such that the engagement tabs 132 engage with respective hooks 372 formed in a cap 370 (described later). Further, two brackets 134 extend from the peripheral wall that forms the light source housing portion 130. A screw insertion hole 135 is formed in a tip end portion of each bracket 134, and a fastening screw 150 is fitted in the screw insertion hole 135 to fasten the side turn signal lamp 10 to the mirror housing 500. It should be noted that, in FIG. 1, the components of the mirror housing 500 to which the bracket 134 is fastened by the fastening screws 150 are omitted.

The light guide member 100 has a flange portion 140 that surrounds a center portion formed by the front surface portion 121 and the back surface portion 122. The flange portion 140 engages with a portion of the outer side wall 510 around the opening portion 520 via a protector 200 (described later) when the side turn signal lamp 10 is attached to the opening portion 520 of the mirror housing 500. As shown in FIG. 3, a plurality of prism steps 125 is formed on the back surface portion 122 of the light guide member 100.

The prism steps 125 function as visual identification prevention means for preventing the configuration inside the mirror housing 500, such as a drive unit for the mirror main body 400, from being visually identified through the light guide member 100 from the outside of the outer side wall 510 of the mirror housing 500. A light that has been emitted from the LEDs 320 and entered the inside of the light guide member 100 from the incident-side end surface 111 of the light guide member 100, and an outside light that has entered the inside of the light guide member 100 from the front surface portion 121 of the light guide member 100, are internally reflected by the prism steps 125. Thus, it is possible to prevent leakage of the light through the back surface portion 122 into the inside of the mirror housing 500.

The protector 200 is a substantially T-shaped single-piece sheet member that is molded from an elastic material, such as sponge and rubber. The protector 200 is formed of an frame portion 210 that is formed along an outer profile of the front surface portion 121 of the light guide member 100, and a wide width portion 220 that is provided on the base end side with respect to the frame portion 210. The frame portion 210 of the protector 200 fills a clearance between the light guide portion 100 and the outer side wall 510 of the mirror housing 500 when the side turn signal lamp 10 is attached to the opening portion 520. In this way, the frame portion 210 functions to prevent noise, which may be caused if direct collision between the light guide member 100 and the outer side wall 510 of the mirror housing 500 occurs due to vibration of the door mirror. The wide width portion 220 of the protector 200 is wound around the light source housing portion 130 of the light guide member 100. This prevents leakage of the light emitted from the LEDs 320 to the vicinity of the light source housing portion 130.

The LED unit assembly 300 is formed of a substrate 310, the LEDs 320, terminals 330, a retaining member 340, an O-ring 360, and the cap 370. The four LEDs 320 are disposed at substantially equal intervals on the distal end side surface of the substrate 310. Further, conductive patterns or contact terminals are provided on the base end side surface of the substrate 310 and electrically connected to one ends of two terminals 330 retained on the retaining member 340.

A ventilation hole 374 and a connector housing 376, which are tubular and project toward the base end side, are formed on the cap 370. Of these two, the ventilation hole 374 functions to provide air ventilation between a light source housing space, which is defined by the light source housing portion 130 and the cap 370, and the outside. As shown in FIG. 4, a filter 375 that traps dust and dirt particles contained in the outside air is provided inside the ventilation hole 374.

The connector housing 376 forms a connector together with the two terminals 330. That is, tip end portions of the two terminals 330 on the base end side project toward the base end side in the connector housing 376. When a plug for supplying electricity to the side turn signal lamp 10 is inserted into the connector housing 376, the tip end portions of the terminals 330 are electrically connected to terminals of the plug.

A plurality of the hook holes 372 is formed in the cap 370. The LED unit assembly 300 is fixed to the light guide member 100 through lance engagement of the engagement tabs 132 provided on the light source housing portion 130 of the light guide member 100 with these hook holes 372. In addition, the O-ring 360 made of an elastic material, such as rubber, is interposed between the cap 370 and the light source housing portion 130. Consequently, as shown in FIG. 4, air ventilation is provided between the light source housing space in which the four LEDs 320 are housed and the outside space only through the ventilation hole 374.

As described above, in the side turn signal lamp 10 according to one or more embodiments of the present invention, a lamp body or the like is not provided on an inner side of the light guide member 100. Accordingly, the lamp itself can be very small and thin, and moreover, the number of components can also be reduced. In addition, the prism steps 125 are formed on the back surface portion 122 of the light guide member 100 as described above, and this can prevent the configuration inside the mirror housing 500 from being visually identified from the outside.

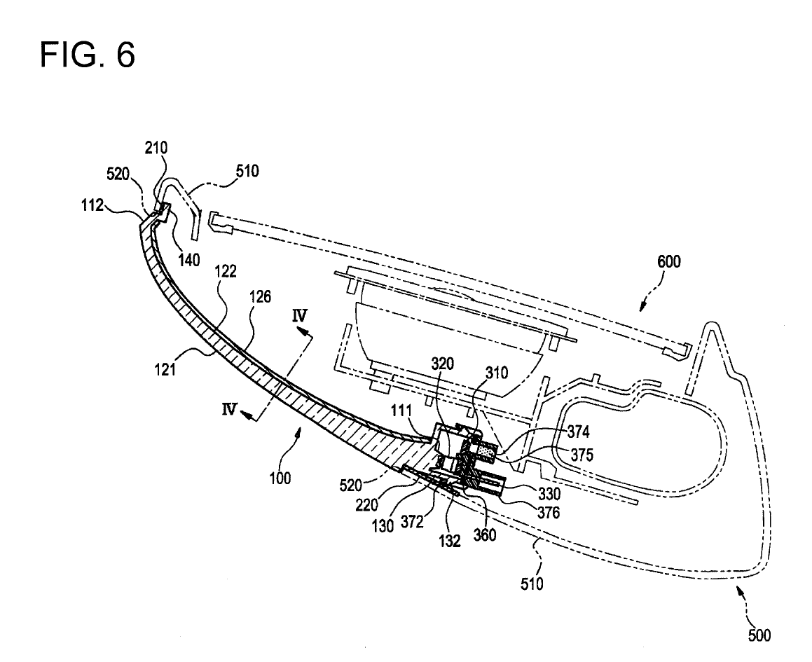

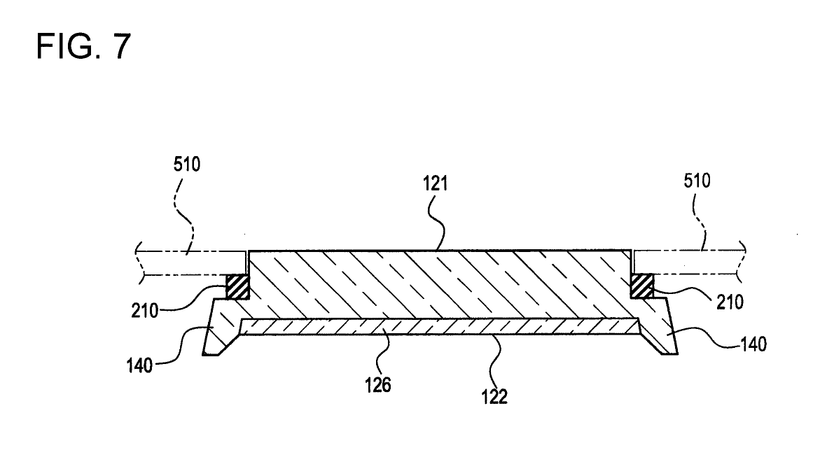

FIG. 6 is a cross-sectional view of a side turn signal lamp 11 according to another embodiment of the present invention, which corresponds to FIG. 2. Further, FIG. 7 is a cross-sectional view of the side turn signal lamp 11 taken along a line IV-IV shown in FIG. 6. In the description of the side turn signal lamp 11 according to one or more embodiments of the present invention, the configurations that are same as or similar to those of the side turn signal lamp 10 will be denoted by the same reference numerals, and the description thereof will be omitted. In the side turn signal lamp 11 according to one or more embodiments of the present invention, a light reflection layer 126 is formed on the back surface portion 122 of the light guide member 100, in place of the prism steps 125 provided in the side turn signal lamp 10 as described above.

The light reflection layer 126 is formed on the back surface portion 122 of the light guide member 100 by, for example, an aluminum deposition method. The light reflection layer 126 reflects the light that has been emitted from the LEDs 320 and entered the inside of the light guide member 100 from the incident-side end surface 111 of the light guide member 100, and an outside light that has entered the inside of the light guide member 100 from the front surface portion 121 of the light guide member 100. Thus, the light reflection layer 126 prevents leakage of the light through the back surface portion 122 to the inside of the mirror housing 500. In other words, similar to the prism steps 125, the light reflection layer 126 functions as the visual identification prevention means for preventing the configuration inside the mirror housing 500 from being visually identified through the light guide member 100 from the outside of the outer side wall 510 of the mirror housing 500.

It should be noted that, the light reflection layer 126 is not limited to a layer formed by the aluminum deposition, and may be any film as long as the light reflection layer 26 has a light transmission prevention function of preventing the configuration inside the mirror housing 500 from being visually identified through the light guide member 100. In the side turn signal lamp 11 according to one or more embodiments of the present invention, the lamp body or the like is not provided on the inner side of the light guide member 100 either. Accordingly, the lamp itself can be very small and thin, and moreover, the number of components can also be reduced. In addition, the light reflection layer 126 is formed on the back surface portion 122 of the light guide member 100 as described above, and this prevents the configuration inside the mirror housing 500 from being visually identified from the outside.

It should be noted that the prism steps 125 may be provided on the back surface portion 122 of the light guide member 100 as in the side turn signal lamp 10, and, in addition, the light reflection layer 126 according to one or more embodiments of the present invention may be formed on a surface of the prism steps 125. This further improves the function as the visual identification prevention means as described above. A hydrophilic layer (not shown) is formed on a surface of the light guide member 100 so as to cover at least a surface of the visual identification prevention means (the prism steps 125, the light reflection layer 126) provided on the back surface portion 122 of the light guide member 100 in the side turn signal lamp 10, 11 described above. Therefore, even when water adheres to the back surface portion 122 and the like of the light guide member 100, the effect of preventing formation of water drops is achieved by the hydrophilic layer. Accordingly, the condition of refraction on the back surface portion 122 of the light guide member 100 in the side turn signal lamp 10, 11 is stabilized regardless of whether water has adhered to the back surface portion 122. This prevents the configuration inside the mirror housing 500 from being visually identified from the outside even when water adheres to the visual identification prevention means described above that is provided on the back surface portion 122 of the light guide member 100.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF THE REFERENCE NUMERALS

10, 11 SIDE TURN SIGNAL LAMP
100 LIGHT GUIDE MEMBER
111 INCIDENT-SIDE END SURFACE
112 OUTPUT-SIDE END SURFACE
121 FRONT SURFACE PORTION
122 BACK SURFACE PORTION
125 PRISM STEP
126 LIGHT REFLECTION LAYER (LIGHT TRANSMISSION PREVENTION LAYER)
130 LIGHT SOURCE HOUSING PORTION
132 ENGAGEMENT TAB
134 BRACKET
135 SCREW INSERTION HOLE
140 FLANGE PORTION
150 FASTENING SCREW
200 PROTECTOR
210 ANNULAR PORTION
220 WIDE WIDTH PORTION
300 LED UNIT ASSEMBLY
310 SUBSTRATE
320 LED (SEMICONDUCTOR LIGHT EMITTING ELEMENT)
330 TERMINAL
340 RETAINING MEMBER
360 O-RING
370 CAP
372 HOOK HOLE
374 VENTILATION HOLE
375 FILTER
376 CONNECTOR HOUSING
400 MIRROR MAIN BODY
500 MIRROR HOUSING
510 OUTER SIDE WALL
520 OPENING PORTION

What is claimed is:

1. A door minor lamp that is attached to an opening portion formed in an outer side surface of a mirror housing, the door mirror lamp comprising:
a light guide member comprising:
an incident-side end surface,
an output-side end surface, and
first and second side surfaces that are formed as substantially opposite surfaces of the light guide member,
wherein the light guide member is attached to the mirror housing such that the output-side end surface and of the first side surface are exposed at the opening portion; and
a semiconductor light emitting element that is disposed in a vicinity of the incident-side end surface and that emits light that enters an inside of the light guide member from the incident-side end surface,
wherein the second side surface is provided with visual identification prevention portion that prevents a configuration inside the mirror housing from being visually identified through the second side surface from outside.

2. The door mirror lamp according to claim 1, wherein the visual identification prevention portion includes a prism step that is formed on the second side surface.

3. The door mirror lamp according to claim 1, wherein the visual identification prevention portion includes a light transmission prevention layer that is formed on the second side surface, and that prevents transmission of the light to the inside of the light guide member through the second side surface.

4. The door mirror lamp according to claim 3, wherein the light transmission prevention layer is a reflection layer that reflects the light from the inside of the light guide member.

5. The door mirror lamp according to claim 1, wherein a hydrophilic layer is formed at least on the second side surface.

6. The door mirror lamp according to claim 2, wherein the visual identification prevention portion includes a light transmission prevention layer that is formed on the second side surface, and that prevents transmission of the light to the inside of the light guide member through the second side surface.

7. The door mirror lamp according to claim 2, wherein a hydrophilic layer is formed at least on the second side surface.

8. The door mirror lamp according to claim 3, wherein a hydrophilic layer is formed at least on the second side surface.

9. The door mirror lamp according to claim 4, wherein a hydrophilic layer is formed at least on the second side surface.

10. The door mirror lamp according to claim 6, wherein a hydrophilic layer is formed at least on the second side surface.
